(19) United States
(12) Patent Application Publication
(10) Pub. No.: US 2017/0303518 A1
(43) Pub. Date: Oct. 26, 2017

(54) Collapsing Fishing Device

(71) Applicant: Thomas Haugen, St. Marks, FL (US)

(72) Inventor: Thomas Haugen, St. Marks, FL (US)

(21) Appl. No.: 15/138,945

(22) Filed: Apr. 26, 2016

(51) Int. Cl. A01K 69/10

(52) U.S. Cl. CPC A01K 69/10

(57) ABSTRACT

The fishing device comprises a first and second side panel connected at a pivot joint, having end panels and a closing system connected thereto. The first and second side panels are preferably curved or rectangular such that an interior void can be formed when the side panels are pivoted together. End panels connect to side panel in order to block access to the interior void from the front and back of device when the side panels meet together. At least two hatch openings are attached to the first and second side panel. Closing system acts to close the catching device, when the device is at the bottom of a body of water.

### CROSS-REFERENCES TO RELATED APPLICATIONS

Not Applicable

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

### 1. Field of the Invention

This invention relates generally to a device for trapping certain fish while releasing other fish. More specifically, the Invention comprises a fish catching device which catches a specific type of fish and excludes other by collapsing.

### 2. Description of the Related Art

Current regulations strictly govern both the size and type of fish that can be caught by a fishing device. A fishing trap must have safeguards in place to prevent substantial by-catch mortality. By-catch mortality is mainly caused by barotrauma which occurs when a fish is exposed to a significant change in ambient pressure, such as when a fish trap is pulled from depth to the surface. Many traps include escape holes or vents of a certain size to permit the release of fish and crustaceans. Additionally, a fisherman often desires to trap one type or particularly sized group of fish.

Fish pots (also known as traps) are used by commercial fishermen and biologists to catch a variety of fish and crustaceans for consumption or study. Most pots are made from a metal wire or nylon web stretched over a steel frame. These pots have one or more openings called funnels which taper into the inside of the pot. Generally, when a fish enters the pot the funnel bends slightly allowing access. Once the fish is inside, the funnel returns back to its original narrowness preventing the fish from escape. As the trap is pulled to the surface trapped fish are exposed to barotrauma. Even though escape holes can be put in the sides of these pots to allow some smaller fish to escape, many juvenile fish and unwanted species are still brought to the surface and must be discarded after experiencing lethal barotrauma. Present day fish pots use biodegradable escape panels which fall off after one or more months allowing fish or crabs to escape if trap is lost or abandoned.

Prior art fish catching devices are capable of excluding fish by allowing a certain sized or shaped fish to enter in an expanding entrance hole or including an adequately sized escape hole. However, the fish in prior an excluding devices-are not forced or encouraged to exit the device while the trap is on the bottom-preventing barotraumas; nor are fish types excluded by their speed. Additionally, current devices require a base in order to catch the fish. Therefore, what is needed is a device which encourages fish to exit the device while the trap is close to the bottom and one that uses speed as a factor, thereby excluding by-catch and promoting the desired catch. Further, it is beneficial to have a trap that utilizes the bottom surface of a body of water, as the temporary base of the device while the device is in an open position. The present invention achieves these objectives, as well as others that are explained in the following description.

### BRIEF SUMMARY OF THE INVENTION

The present invention comprises a catching device which is generally comprised of a first and second side panel connected at a pivot joint, having end panels and a closing system connected thereto. The first and second side panels are preferably curved or rectangular such that an interior void cars be formed when the side panels are pivoted together, End panels connect to side panel in order to block access to the interior void from the front and back of device when the side panels meet together. Closing system acts to close the catching device, when the device Is at the bottom of a body of water. The present catching device allows a user to trap a particularly type of fish and encourages undesirable fish to exit catching device as the device closes. Importantly, the device is capable of opening and closing while submerged within a body of water. Thus, the escaping fish are released directly back to their native depth environment eliminating barotrauma.

Openings in the present catching device are conduits between the body of water and the interior of the catching device. Upon retrieving the device, a user causes a tether (line) attached to closing system to exert an upward force in such a way so as to begin to close the device. As the side panels are pulled toward one another, a bottom opening is formed. Bottom opening is only accessible to the fish as the device transitions from an open position to a closed position and for a limited time. Because fish are sensitive to touch, a majority of fish will attempt to exit the device during the time frame in which the device is collapsing. The faster swimming fish are more likely to exit the trap during the transition. The simultaneous action of the reduction of space inside of the device and the opening (and closing) of the bottom opening allows the user to screen further for the desired type of fish, by encouraging faster swimming fish to exit through the bottom opening.

The present catching device can also contain a plurality of auxiliary openings to release smaller by-catch, lit one embodiment, hatch openings are formed in the wall of the side panels. Batch opening provides access to the interior void of the catching device. The bottom of the device in the opening position is the surface of the pertinent body of water. Thus, the fish are encouraged to enter the natural environment though the hatch opening to the interior of the catching device.

### BRIEF DESCRIPTION OF THE SEVERAL VIEWS OF THE DRAWINGS

FIG. 1 is a perspective view, showing the present invention.

FIG. 2 is an elevation view, showing the present invention in an open position.

FIG. 3 is a perspective view, showing the device transitioning from an open position to a closed position.

FIG, 4 is an elevation view, showing the device transitioning from an open position to a closed position.

FIG. 5 is a perspective view, showing the device fully closed.

FIG. 6 is an elevation view, showing the device closed.

FIG. 7 is a perspective view, showing an alternate embodiment of the present invention.

FIG. 8 is a perspective view, showing an alternate embodiment of the present invention transitioning from an open position to a closed position.

FIG. 9 is a perspective view, showing an alternate embodiment of the present invention fully closed.

FIG. 10 is a perspective view of the present invention in an open position.

FIG. 11 is a perspective view of the present invention in an open position.

FIG. 12 is a perspective view of the present invention transitioning between an open position and a closed position.

FIG. 13 is a perspective view of the present invention in a closed position.

FIG. 14 is a perspective view of the present invention in an open position.

FIG. 15 is a cross section view of the present invention in an open position.

FIG. 16 is a perspective view of the present invention transitioning from an open position to a closed position.

FIG. 17 is a perspective view of the present invention transitioning from an open position to a closed position.

FIG. 18 is a perspective view of the present invention in a closed position.

FIG. 19 is a cross section view of the present invention in a closed position.

### REFERENCE NUMERALS IN THE DRAWINGS

10 catching device
11 closing system
12 first side panel
14 second side panel
16 joint
18 actuating linkage
20 wedge
22 first front panel
24 second front panel
26 linkage
28 surface
30 opening
32 first exterior panel
34 second exterior panel
36 connector
38 opening
40 guide
42 lever
44 line
46 bottom opening
48 hatch opening
50 hatch panel
54 pivot point
56 attachment
58 internal cavity
60 panel
62 central linkage
64 chord linkage

### DETAILED DESCRIPTION OF THE INVENTION

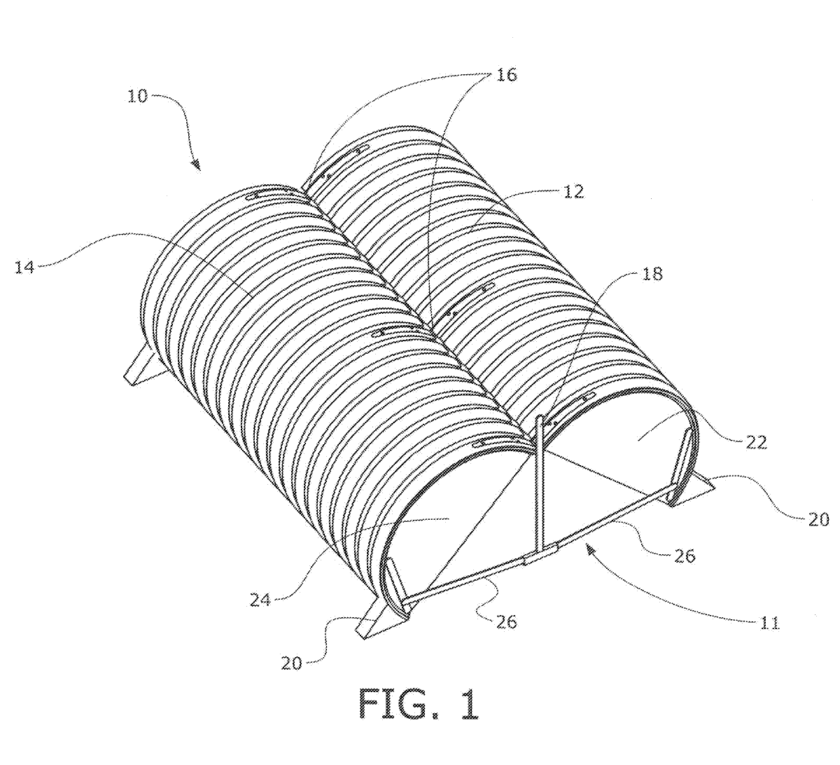

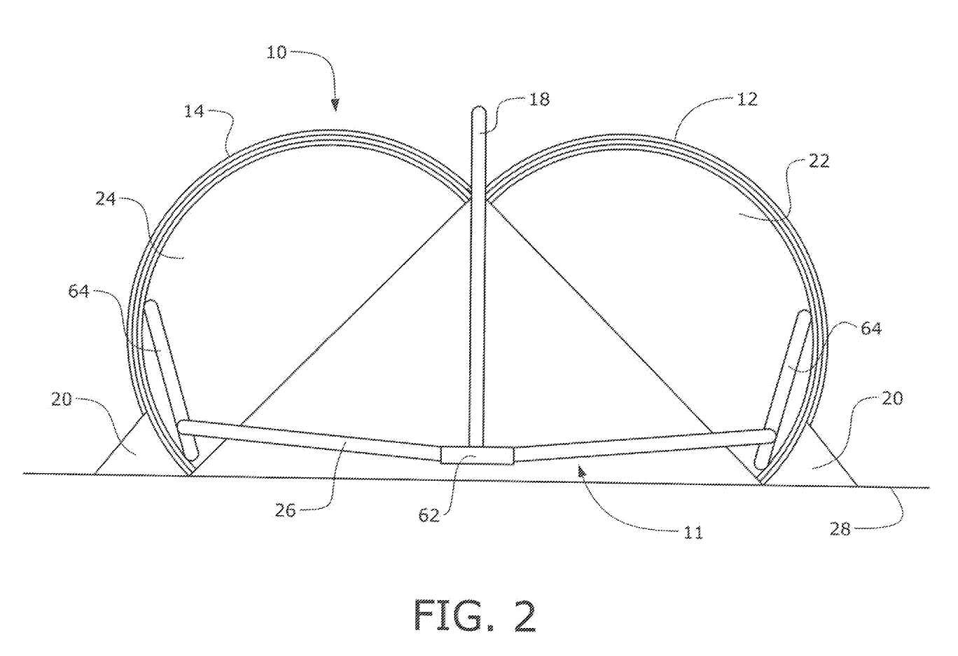

The present invention is illustrated in FIG. 1. As the present catching device 10 doses it transitions from a first position through a second position to a third position. As the device closes, supplementary openings are provided for the fish to exit the device, thereby excluding by-catch. The device is capable of closing along or close to the bottom surface of a body of water.

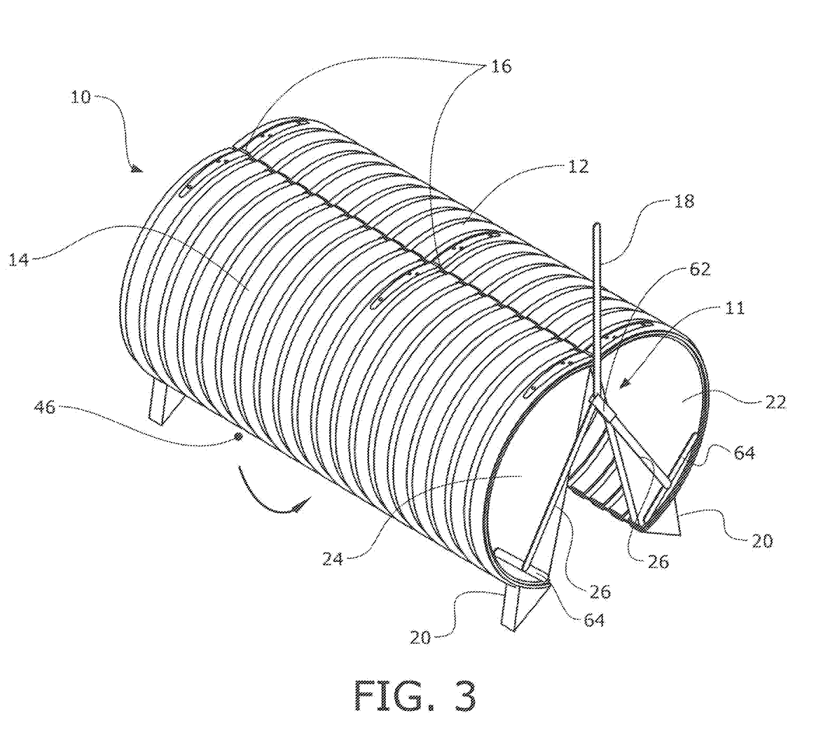

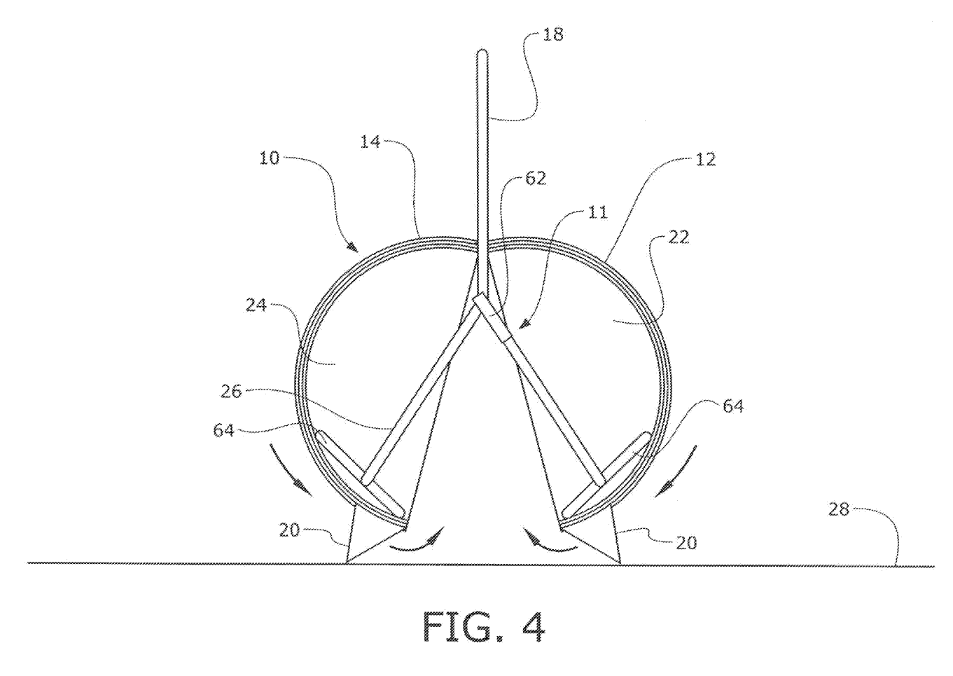

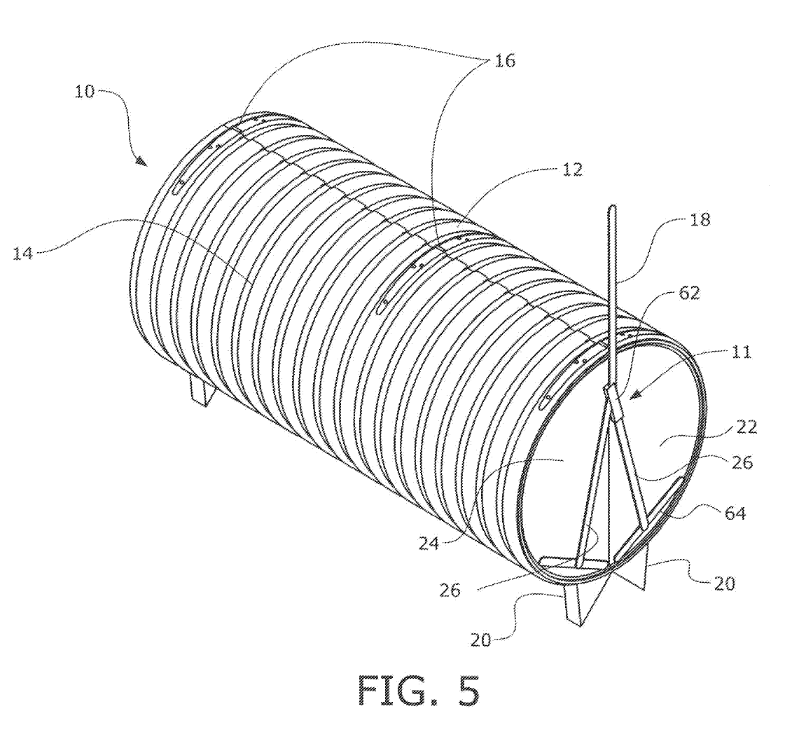

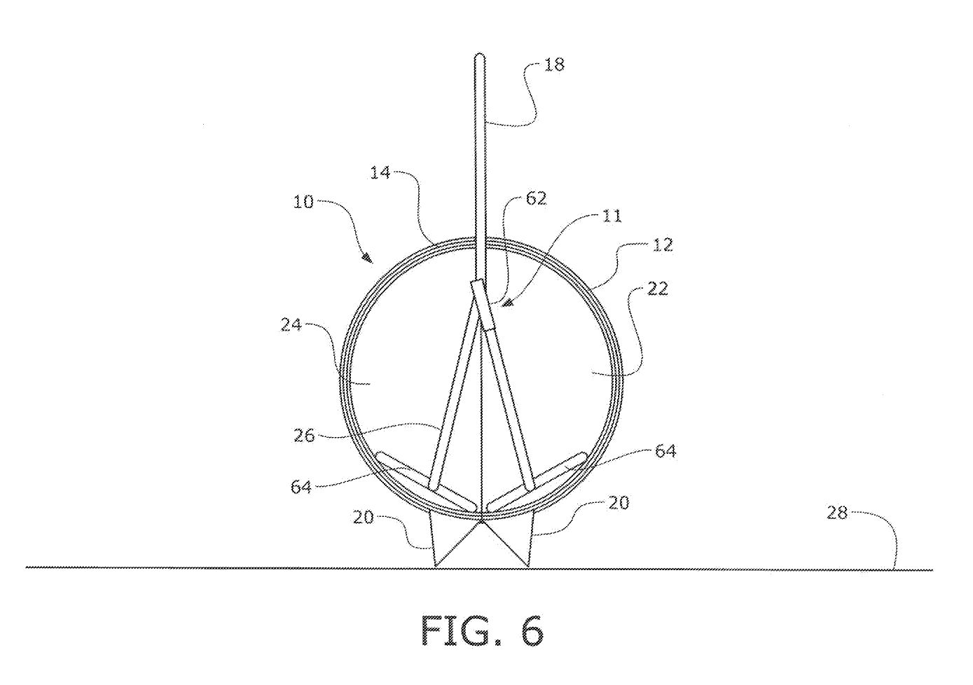

In the first position, device 10 is open, resting on the surface 28 of the body of water and has at least two openings 30, as illustrated in FIGS. 1-2 (opening 30 on one end of device is identical to the other end, not shown). Fish can exit or enter either opening 30. During the transition, in the second position, additional access and escape openings 46 are provided for the fish, as shown in FIGS. 3-4. This allows the device to exclude smaller fester swimming fish as the device closes. Device 10 is closed in the third position, and can optionally have a small opening (not shown) for by-catch to exit (FIGS. 5-6). The device 10 cars be lifted out of the water in the closed position.

Returning to FIG. 1, the present invention is generally comprised of a first side panel 12 and second side panel 14 connected at a pivot joint 16, end panels 22, a series of wedges 20 and a closing system 11. First and second side panel 12, 14 have a first end, second end, top end and bottom edge. While the term, “side panel” is used herein, it should be understood by the reader to be inclusive of any sides, tops or bottoms of the described or illustrated panel. Additionally, the “side panel” can be any shape or size. Pivot joint 16 connects the top of side panels 12, 14 together, such that side panels 12, 14 can pivot open or closed. First and second ends of side panels 12, 14 have end panels 22. A series of wedges 20 attach to the bottom end/edge of side panels 12, 14 such that wedges, having two legs meeting at a vertex point, are capable of maintaining contact with surface 28 (shown in FIG. 2). Closing system 11 is a series of linkages 26 which, connect to side panels 12, 14 and end panels 22 such that an actuating linkage 18 can be pulled upward to close the device 10.

FIG. 2 is an elevation view showing the catching device 10. One leg of each wedge 20 provides a stable base for device 10 in an open position along the bottom surface of a body of water. Each wedge is comprised of two legs meeting at a vertex point. One leg of each wedge 20 rests flat on surface 28. Closing system 11 is shown in detail in FIG. 2. Chord linkage members 64 attach to end panel 24 at the edges of side panels 14, 16 such that chord linkage members 65 form a chord along the curve of first and second side panels 14, 16. An additional two linkage members 26 connect chord linkage members 64 to a central linkage 62. An actuating linkage 18 extends upward, from central linkage 62. As the user pulls upward on actuating linkage 18, linkage members 26 and chord linkage members 64, are pulled upward and inward, transitioning device into a second position, as shown in FIG. 3. As the device transitions, closing system 11 causes first side panel 12 and second side panel 14 to pivot closer together, dragging wedge along surface 28, as illustrated in FIG. 4. As wedges 20 move inward, its contact with surface 28 transitions from the leg of wedge to the vertex point of wedge 20. As the vertex point of wedge 20 begins to contact surface 28, first, and second side panel (12, 14) lift off of surface 28 such that bottom opening 46 is formed (illustrated in FIG. 3). Bottom opening 46 allows fish to escape or enter beneath catching device 10. The additional opening 46 not only prevents by-catch by allowing fester fish to escape, but it also prevents sea life on the surface 28 from being trapped by catching device 10.

FIG. 5 and 6 illustrate catching device 10 in a fully closed position. First side panel 12 and second side panel 14 meet together, closing all openings. Slower moving fish are trapped in the interior void within catching device 10. Catching device 10 can be pulled to the top of the body of water by attaching a jute line to actuating linkage 18.

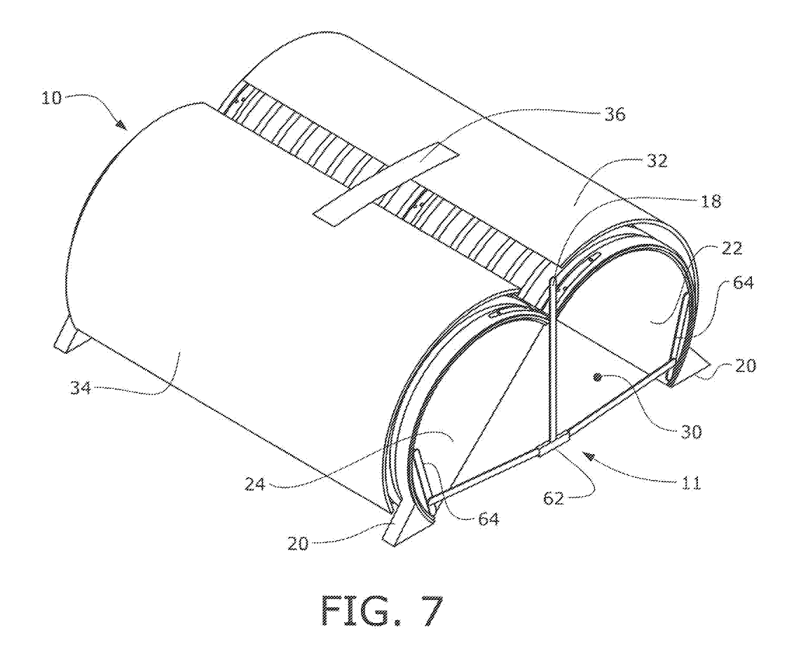

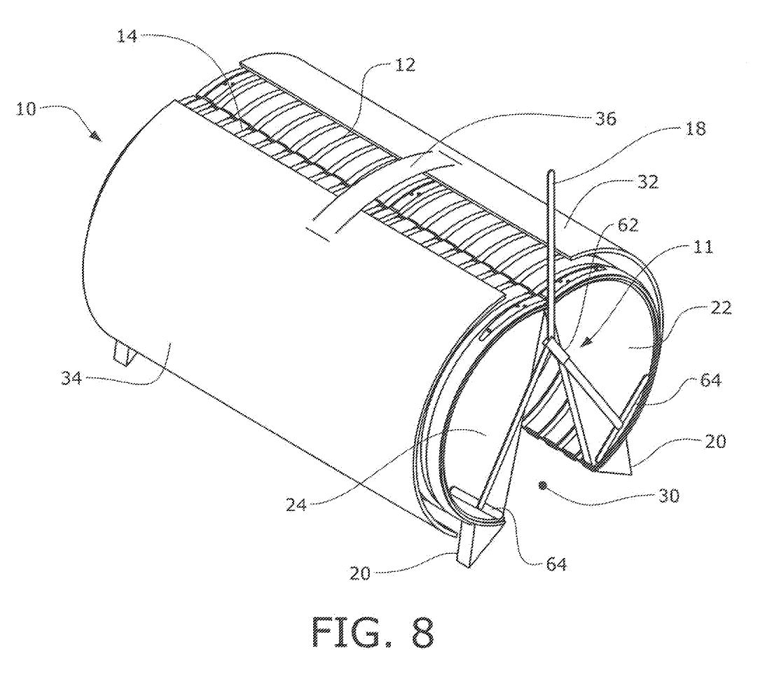

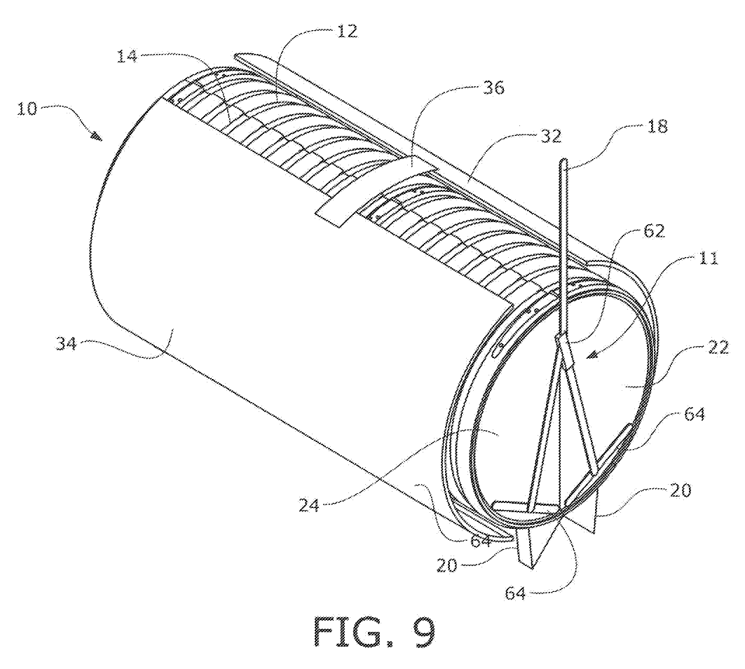

FIGS. 7-9 show an alternate embodiment of the present invention, in a first position, second position arid third position, respectively. In the alternate embodiment, first exterior panel 32 and second exterior panel 34 are attached to catching device 10 such that exterior panels are capable of urging fish towards openings in catching device 10. Exterior panels (32, 34) are attached together by connector 36. As catching device 10 is transitioning from a first position to a third position, exterior panels (32, 34) mimic the movement of first and second side panels (12,14), illustrated in FIG. 8. FIG. 9 shows the alternate embodiment in a fully closed position, with first and second exterior panels (32, 34) fully wrapped around catching device 10.

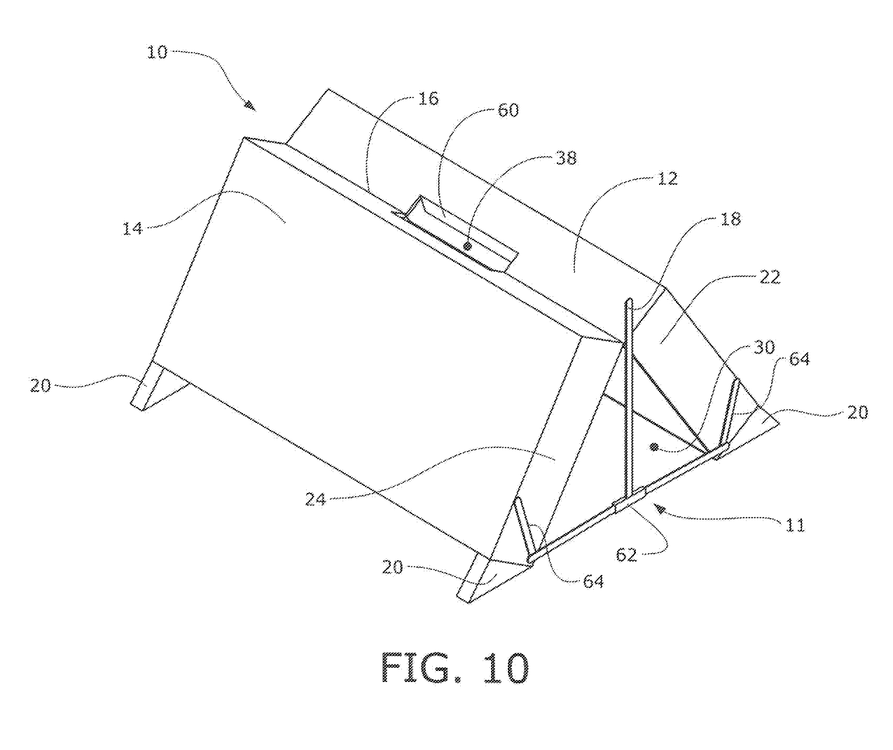

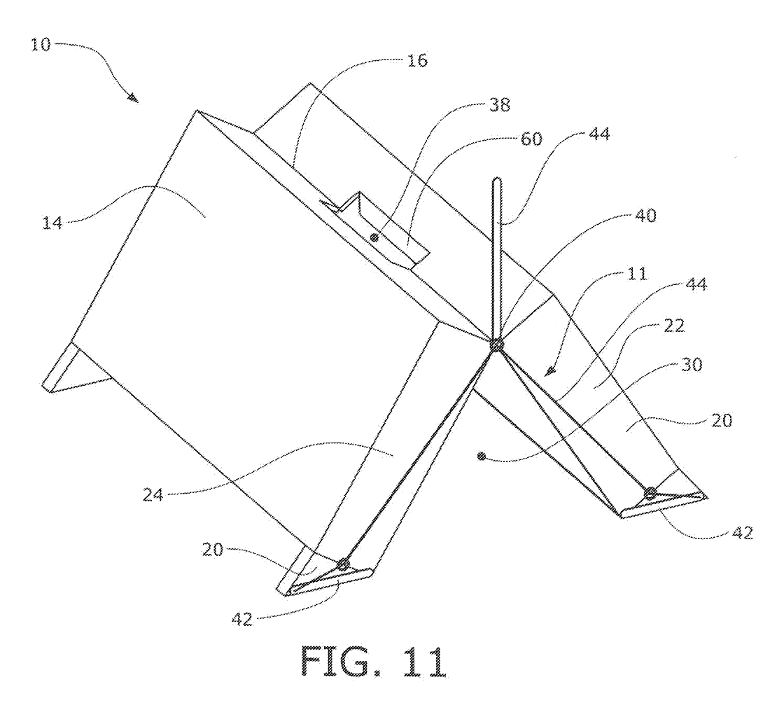

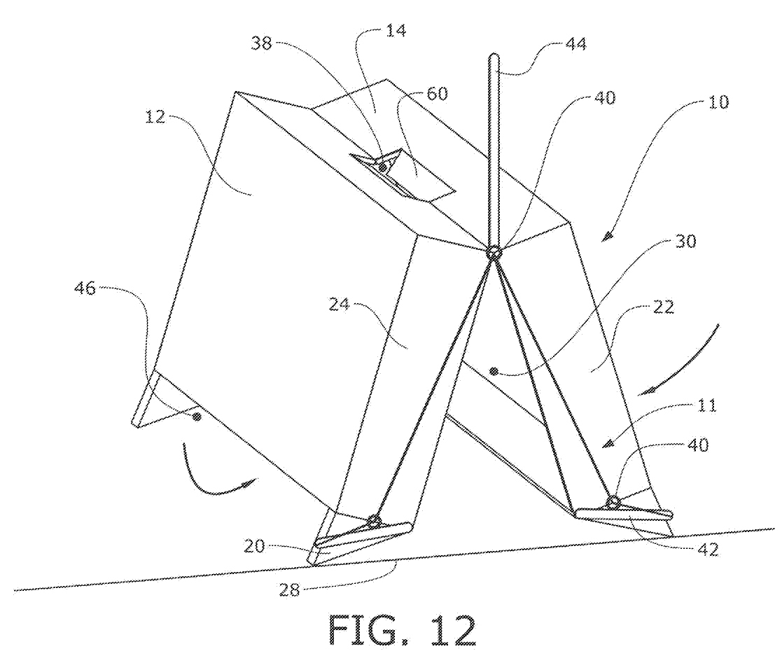

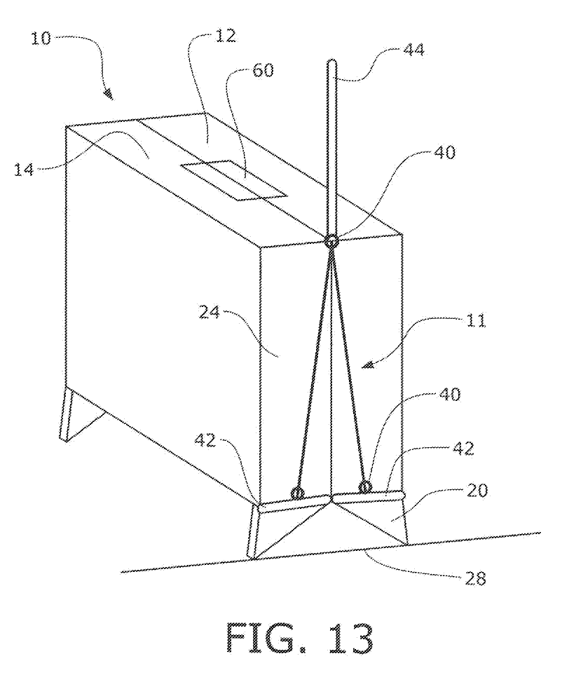

Catching device 10 is shown in FIGS. 10-18 having a different shape. First and second side panels (12,14) are rectangular and include an opening 38 on the top of device 10. End panels 22, 24 are integral with first and second side panels 12, 14. Opening 38 provides an auxiliary exit for small fish to escape out of device 10. Smaller fish are typically unwanted by-catch and therefore it is desirable to allow these smaller fish to exit catching device 10. As illustrated in FIG. 10, the leg of each wedge 20 rests on the bottom surface (not shown) of the body of water such that a larger opening 30 is formed. Fish can enter and exit catching device 10 through opening 30, when catching device 10 is in a first position. The reader will appreciate that closing system 11, in FIG. 10, functions in exactly the same manner as shown and described in FIGS. 1 -6, while closing system 11 in FIG. 11 is very similar. Closing system 11 in FIG. 11 is comprised of a line 44, guides 40 and levers 42. Line 44 is preferably a strong wire or thread, such as a jute line. Guides 40 are preferably circular and allow line 44 to slide through a central cavity in guide 40. As the user applies upward force to line 44, levers 42 shift upward, pulling first side panel 12 and second side panel 14 towards one another, as illustrated in FIG. 12. As first and second side panels (12, 14) move together the vertex point of each wedge 20 contacts surface 28 and lifts side panels (12, 14) off of surface 28 thereby creating bottom opening 46 under device 10. The auxiliary opening 38 on the top of device 10 includes two panels 60 which closes as the side panels (12, 14) move together. FIG. 13 illustrates device 10 in a folly closed position. As illustrated, side panels 12, 14 and panels 60 meet together to prevent exit from the interior void of catching device 10. Although not visible in FIG. 13, side panels 12, 14 include a bottom edge under catching device 10 such that fish caught inside of catching device 10 are unable to exit. Bottom edge of side panels 12, 14 is visible in FIG. 12.

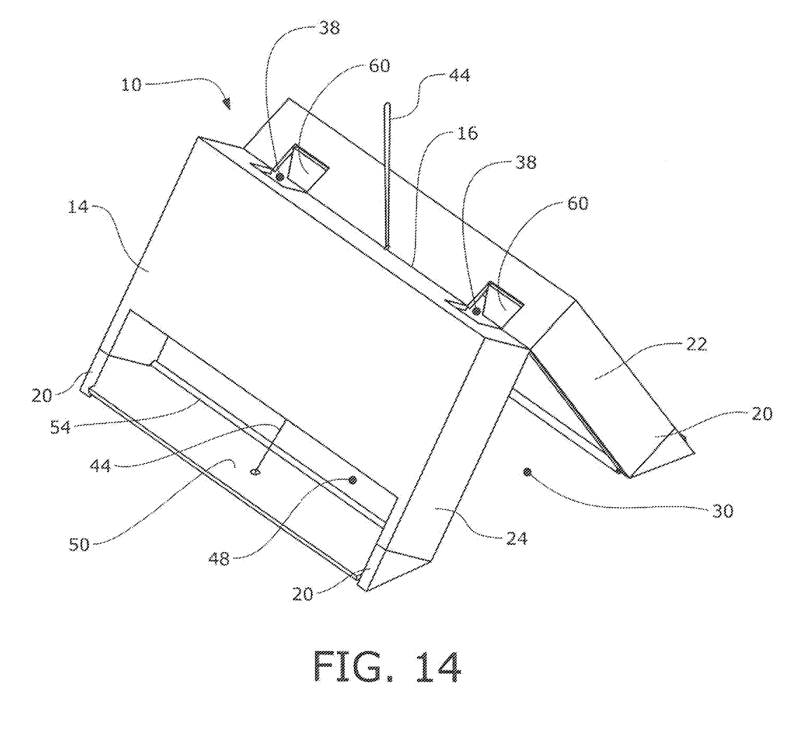

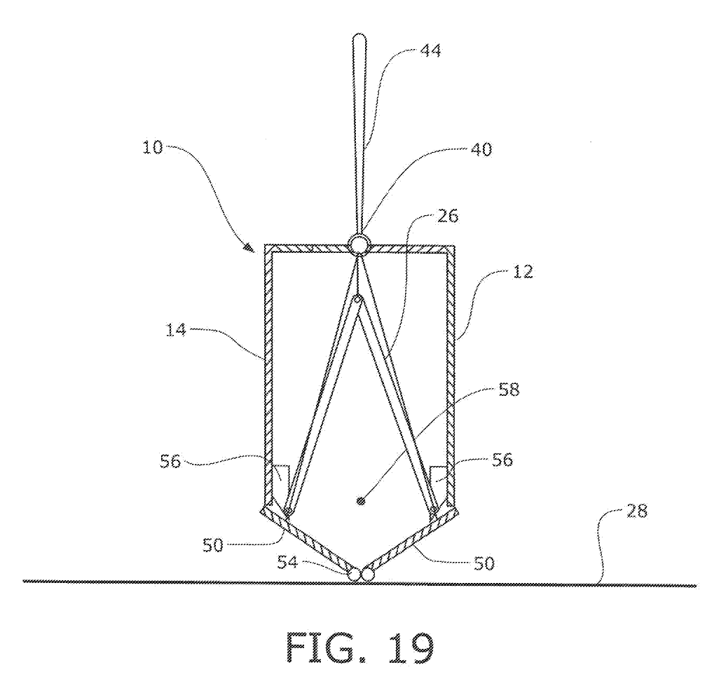

FIGS. 14-19 illustrate one embodiment of the present catching device 10. Catching device 10 includes several openings when in a first position (open position), shown in FIGS. 14, Hatch openings 48, top opening 38 and openings 30 all permit access to the interior area (cavity) of device 10. Because catching device 10 sits on the surface of a body of water, the base of catching device 10 in the open position is the bottom or surface of the body of water. Sea life are encouraged to enter catching device 10 because the use of the body of water surface creates a more natural environment.

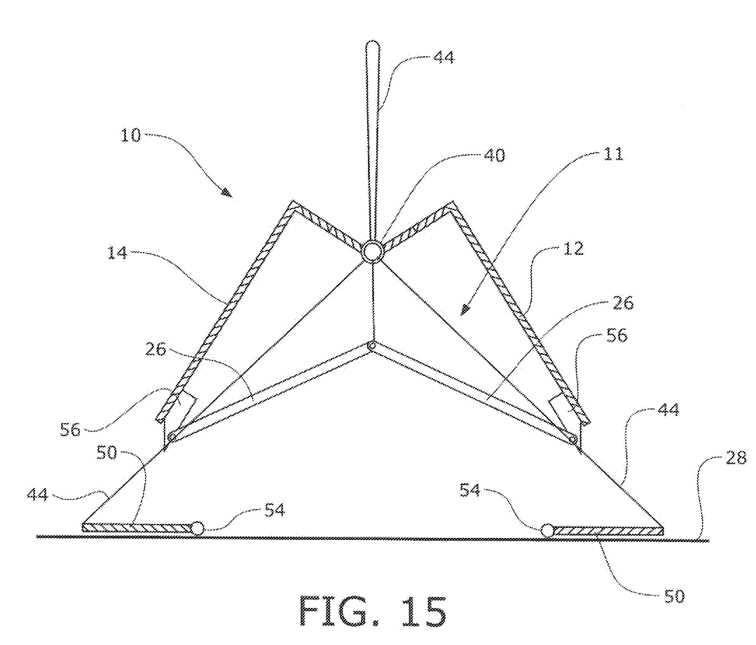

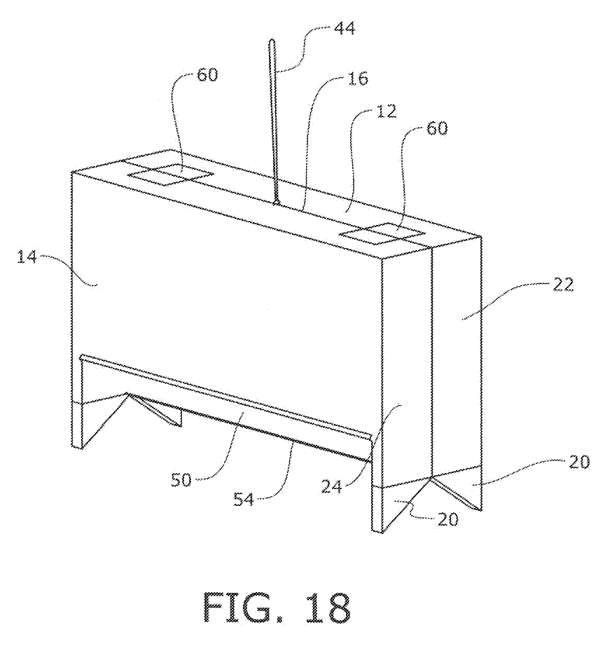

Hatch openings 48 are preferably located on each side panel 12, 14. An interior pivot point 54 (hinge) connects hatch panels 50 to first and second side panels 12, 14 respectively. Hatch panels 50 lie flat against surface 28 in an open position, as illustrated in a cross section view in FIG. 15. A second set of hinges located on attachment 56 allow hatch panels 50 to close against first and second side panels 12, 14 (described and illustrated in FIG. 18). Closing system 11 operates in a similar manner as shown and described in FIG. 11. Closing system 11 is comprised of line 44, at least three guides 40 and a set of hatch panels 50, as shown in FIGS. 14-15. There may be one or two closing systems on one catching device 10. FIG. 15 shows a cross section view of the present closing system 11. Line 44 passes through guides 40 within the interior of catching device 10 and connects to panels 50. Pivot points (interior pivot point 54 and hinge located, on attachment 56) allow panels 50 to pivot with respect to side panels 12, 14. As the user provides an upward force on line 44 panels 50 begin to lift off of surface 28. Line 44 is also capable of connecting to a central point where two linkages 26 meet and also extends downward through two guides 40 (not visible) on attachment 56 to connect to panels 50. As the line 44 is pulled upward, line 44 trips the linkage 26, causing linkage 26 to pull side panels 12, 14 inward while line 44 also pulls panels 50 upward.

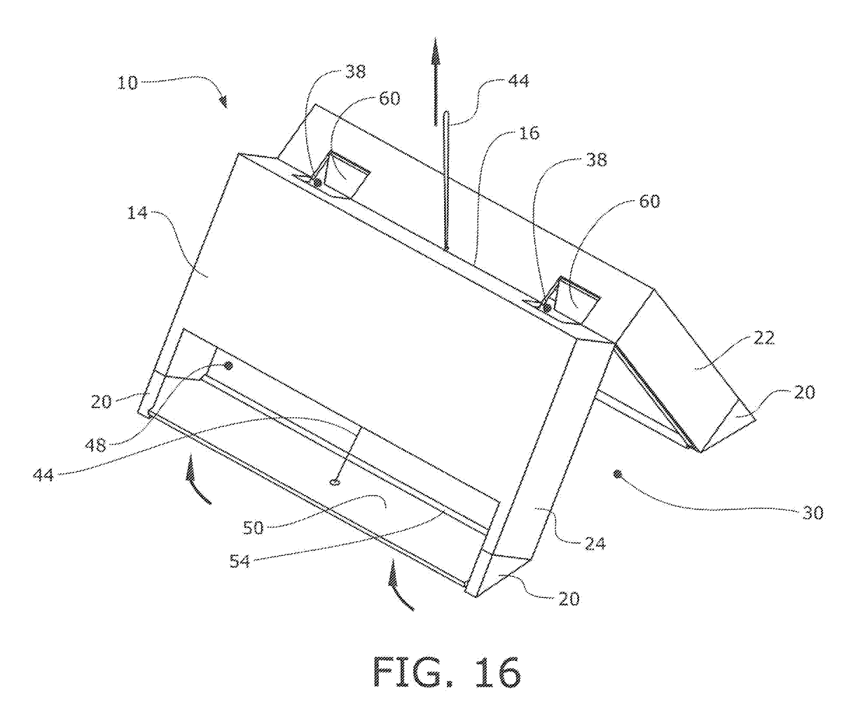

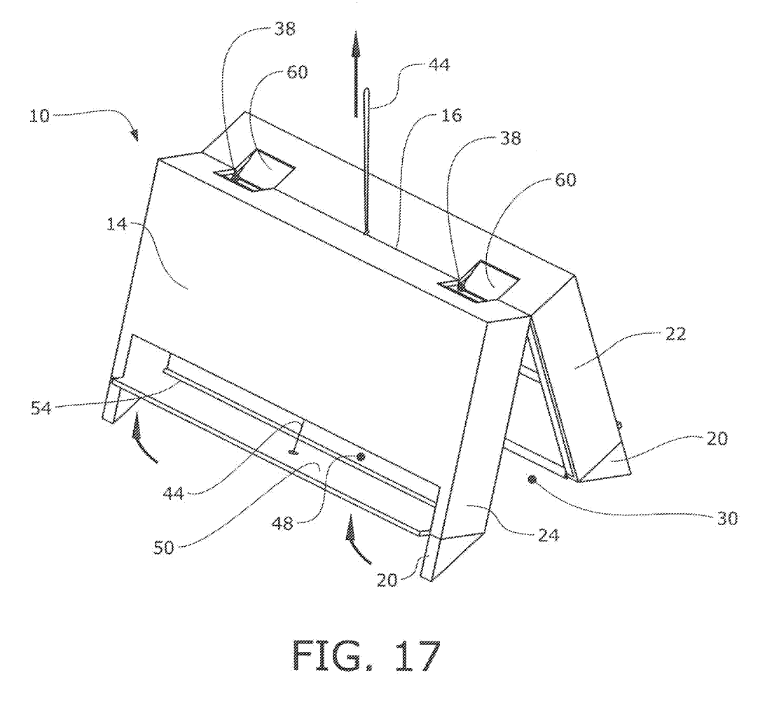

FIGS. 16 and 17 illustrate catching device 10 transitioning between an open position and a closed position. Again as an upward force is applied to line 44, panels 50 lift off of surface and begin to close around hatch opening 48. The force being applied to line 44 also pulls first and second side panel 12, 14 toward one another. As this occurs, the vertex point of each wedge 20 contacts the surface of the body of water lifting the leg of each wedge 20 off of the surface. When this occurs a bottom opening 46 is formed which allows unwanted by-catch to exit the device. Hatch opening 48 encourages sea life towards the Interior of catching device 10. A lip 58 is provided along the edge of hatch opening 48, such that panels 50 do not pass directly through hatch opening 48 Into the interior of catching device 10.

Catching device 10 is shown in a closed position in FIG. 18. Top opening 38 (shown in FIG. 16) is closed by panels 60. Panels 50 fully eliminate hatch opening 48. First and second side panels 12 and 14 eliminate opening 30 and bottom opening 46. Catching device 10 can be pulled to the surface of the body of water in a closed position.

The preceding description contains significant detail regarding the novel aspects of the present invention. It should not be construed, however, as limiting the scope of the invention but rather as providing illustrations of the preferred embodiments of the invention. As an example, additional entries and exits can be added to the present invention. Additionally, catching device can be released mechanically as opposed to by a force generated from a fishing or jute line.

Having described my invention, I claim;

1. A fishing device for use in a body of water having a surface, wherein said fishing device comprises;
a first side panel and a second side panel having a first end, second end, top end and bottom end;
wherein said first side panel and said second side panel are attached together at said top end by a pivot joint such that said first and second side panel can pivot from an open position to a closed position;
a plurality of end panels attached to said first end and said second end of said first and second side panel;
a plurality of wedges attached to said bottom end of said first and second side panels; and
a closing system configured such that said closing system is capable of opening and closing said fishing device.

2. The fishing device as recited in claim 1, wherein said plurality of end panels are integral with said first side panel and said second side panel.

3. The fishing device as recited in claim 1, wherein said plurality of wedges further comprises at least two legs which meet at a vertex point.

4. The fishing device as recited in claim 1, wherein said plurality of wedges is integral with said first side panel and said second side panel.

5. The fishing device as recited in claim 1, wherein said closing system is integral with said first and second side panel.

6. The fishing device as recited in claim 1, wherein said closing system further comprises a series of linkages which connect to said first side panel and said second side panel such that an actuating linkage can be pulled upward to close said fishing device.

7. The fishing device as recited in claim 1, wherein said fishing device further comprises:
a plurality of hatch panels attached to said first side panel and said second side panel; wherein said plurality of hatch panels allow access to an interior of said fishing device
via a plurality of hatch openings in said open position; and
wherein said plurality of hatch panels meet said first and second side panels in said closed position.

8. The fishing device as recited in claim 7, wherein said plurality of hatch panels are attached to said first side panel and said second side panel at a pivot point.

9. The fishing device as recited in claim wherein said closing system further comprises
a plurality of guides attached to said first side panel and said second panel; and
a line threaded through guides and attached to said hatch panels, such that hatch panels lift upwards as said line is pulled upward.

10. The fishing device as recited in claim 9, wherein said closing system further comprises,
at least two attachments which connect to said first side panel and said second side panel respectively;
at least two linkage members pivotally attached to said at least two attachments; and
wherein said at least two linkage members are pivotally attached to one another at a central point.

11. The fishing device as recited in claim 10, wherein said line is attached to said central point on said at least two linkage members.

12. The fishing device as recited in claim 11, wherein said first side panel and said second side panel have at least one top opening.

13. A fishing device for use in a body of water having a surface, wherein said fishing device comprises:
a first side panel having at least two end panels;
a second side panel pivotally attached to said first side panel such that said first side panel, and said second side panel form an interior, wherein said second side panel has at least two end panels;
a closing system attached to said first side panel and said second side panel;
a first hatch panel attached to said closing system and pivotally attached to said first side panel; and
a second hatch panel attached to said closing system and pivotally attached to said second side panel.

14. The fishing device as recited in claim 13, wherein said closing system further comprises:
an attachment piece attached to said first side panel and said second side panel;
at least two linkages pivotally attached to said attachment piece;
a line attached to at least two linkages at a central point, said first hatch panel and said second hatch panel; and
wherein said line is threaded through a series of guides attached to said first side panel and said second side panel.

15. The fishing device as recited in claim 13, wherein said plurality of end panels are integral with said first side panel and said second side panel.

16. The fishing device as recited in claim 13, wherein said first side panel and said second side panel further comprise a plurality of wedges having at least two legs which meet at a vertex point.

17. The fishing device as recited in claim 14, wherein said fishing device closes when a user pulls upward on said line, thereby pulling said at least two linkages and said first and second hatch panels upwards.

18. The fishing device as recited in claim 16, wherein said plurality of hatch panels allow access to an interior of said fishing device via a plurality of hatch openings in said open position; and wherein said plurality of hatch panels meet said first and second side panels in said closed position.

19. A fishing device for use in a body of water having a surface, wherein said catching device comprises:
a first side panel having at least two end panels, wherein said at least two end panels have a bottom end;
a second side panel pivotally attached to said first side panel;
wherein said second side panel has at least two end panels, wherein said at least two end panels have a bottom end;
wherein said bottom end of said at least two end panels of said first side panel and said at least two end panels of said second side panel form a wedge having a first leg and a second leg meeting at a vertex point;
a first hatch panel pivotally attached to said first side panel;
a second hatch panel pivotally attached to said second side panel;
a closing system attached to said first side panel and said second side panel and said first hatch panel and said second hatch panel;
wherein said closing system is configured to transition said fishing device from a first position to a second position to a third position;
wherein In said first position, said first side panel and said second side panel are pivoted away from one another such that said first legs of said first side panels are resting on said surface of said body of water, an opening is formed between said at least two end panels of said first side panel and said at least two end panels of said second side panel, and at least two hatch openings are formed by said first and second hatch panels;
wherein in said second position, said first and second hatch panels are pulled upwards towards said first and second side panels and said bottom end of said wedge of said first and second side panels are pulled closer together such that said vertex point of said wedges contacts said surface of said body of water and lifts said first legs of said first and second side panels off of said surface such that a bottom opening is formed; and
wherein n said third position, said first and second hatch panels contact said first and second side panels such that said hatch opening is closed, and said end panels of said first and second side panels meet to close said opening such that said interior is fully enclosed.
